(19) United States
(12) Patent Application Publication
(10) Pub. No.: US 2001/0027066 A1
(43) Pub. Date: Oct. 4, 2001

(54) Modular power connector system

(76) Inventor: Pit-Kin Loh, Seremban (MY)

Correspondence Address: MICHAEL BEST & FRIEDRICH, LLP, 100 E WISCONSIN AVENUE, MILWAUKEE, WI, 53202, US

(21) Appl. No.: 09/742,208

(22) Filed: Dec. 20, 2000

Related U.S. Application Data
(60) Provisional application No. 60/172,758, filed on Dec. 20, 1999.

(51) Int. Cl. H01R 25/00; H01R 27/02; H01R 31/00; H01R 33/88; H01R 33/90; H01R 33/92; H01R 33/94; H01R 13/502; H01R 13/514

(52) U.S. Cl. 439/701; 439/652

(57) ABSTRACT

An expandable power connector module in the form of a modular power board or modular power strip 10 is described. The modular power board 10 includes a plurality of power sockets 12 provided on a base structure 14, each of the power sockets being connected to a power cord 16 for connection to a mains supply power outlet. The base structure 14 is designed to connect to one or more additional power modules and is provided with snap-on connectors 20 for physically connecting the base structure to a second power board 22. In this way, the function of the power board can be expanded to provide additional power connection and/or power conditioning features by connecting one or more additional power modules. The base structures 14 and 26 are also provided with electrical connectors for electrically connecting each of the power sockets 12 on the second power board 22 with the power cord 16 of the first power board 10. The base structure 26 of the second power board 22 may also be connected to an additional power module in the form of a battery backup module 30. The battery backup module 30 is also provided with snap-on connectors 32 on either side of an upper surface of a casing 34. Either one or both of the modular power strips and battery backup module 30 are provided with electronic switching means therein for controlling the supply of electrical power from the battery backup module 30 to the power sockets 12 in the first and second power strips in the event of a failure in the mains power supply. In this way, when the power connector modules and battery backup module are connected together they form a modular uninterruptible power supply (UPS).

### FIELD OF THE INVENTION

The present invention relates to a modular power connector system and an expandable power connector module for connecting one or more electrical devices to a mains power supply and relates particularly, though not exclusively, to a modular uninterruptible power supply (UPS).

### BACKGROUND TO THE INVENTION

A typical desktop personal computer (PC) is normally attached to a number of peripheral devices such as, for example, a printer, a scanner, a facsimile machine, loud speakers, a microphone and/or a video camera. Each of these peripheral devices normally requires connection to the mains power supply, resulting in the need for multiple power sockets. Many PC users buy a multiple socket power board with built-in surge protection for this purpose. However, frequently commercial power boards come with insufficient sockets and it is not unusual for PC users to “piggy back” several power boards and/or to use a plurality of double adaptors in conjunction with the power board. There is thus a need for a power board that can be readily expanded to accommodate additional power sockets.

Furthermore, the present inventor also realised that by making a power board expandable, there was opportunity to incorporate additional power conditioning features, such as battery backup, to form an uninterruptible power supply (UPS).

### SUMMARY OF THE INVENTION

The present invention was developed with a view to providing an expandable power connector module which can optionally be expanded to form a modular UPS.

According to one aspect of the present invention there is provided an expandable power connector module for connecting one or more electrical devices to a mains power supply outlet, the power connector module comprising:

a plurality of power sockets provided on a base structure, each of said power sockets being connected to a power cord for connection to a mains power supply outlet, the base structure being adapted to connect to one or more additional power modules and being provided with mechanical connecting means for physically connecting the base structure to said one or more additional power modules whereby, in use, the function of said power connector module can be expanded to provide additional power connection, power protection and/or power conditioning features.

Preferably said base structure is also provided with electrical connecting means for electrically connecting each of said power sockets to said one or more additional power modules.

In one embodiment said power connector module is in the form of a first modular power board having said plurality of power sockets arranged side by side in a linear array, and further comprising a power switch for connecting or disconnecting said power sockets from the power cord. In a preferred embodiment said linear array is one of a pair of linear arrays of sockets provided on the power board. Alternatively, the first modular power board has a plurality of power sockets arranged in a single linear array and said base structure is adapted to connect to a second modular power board also having a plurality of power sockets arranged in a linear array. Preferably either one or both of said first and second modular power boards is provided with surge protection means electrically connected to each of said plurality of power sockets for protecting any devices connected to the sockets from excessive power surges in the mains power supply.

Advantageously said base structure of the power connector module is adapted to connect to an additional power module in the form of a battery backup module, for providing battery backup to any devices connected to the power sockets in the event of a failure in the mains power supply. Advantageously said base structure snaps on to an upper surface of the battery backup module. Preferably said battery backup module together with said power connector module form a modular uninterruptible power supply (UPS). Advantageously said battery backup module is provided with a stackable housing whereby, in use, two or more of said battery backup modules can be stacked one on top of the other to increase the backup power or backup time.

According to another aspect of the present invention there is provided a modular uninterruptible power supply (UPS) comprising:

a power connector module having a plurality of power sockets provided on a base structure, the base structure being adapted to connect to one or more additional power modules and being provided with mechanical connecting means for physically connecting the base structure to said one or more additional power modules;

an additional power module in the form of a battery backup module for providing battery backup to any devices connected to the power sockets on the power connector module; and,

electronic switching means provided in either one or both of said power connector module and battery backup module for controlling the supply of electrical power from the battery backup module to the power sockets in the event of a failure in the mains power supply whereby, in use, when said power connector module and battery backup module are connected together they form an UPS.

Advantageously said battery backup module is provided with a stackable housing whereby, in use, two or more of said battery backup modules can be stacked one on top of the other to increase the backup power or backup time.

### BRIEF DESCRIPTION OF THE DRAWINGS

In order to facilitate a better understanding of the nature of the invention preferred embodiments of the power connector module and additional power modules will now be described in detail, by way of example only, which reference to the accompanying drawings, in which:

FIG. 1 illustrates a first embodiment of a modular power board in accordance with the present invention;

FIG. 2 illustrates the power board of FIG. 1 connected to a second modular power board;

FIG. 3 illustrates a preferred embodiment of a battery backup module that can be connected to the first and second modular power boards of FIG. 2;

FIG. 4 illustrates the modular power boards of FIGS. 1 & 2 connected to the battery backup module of FIG. 3;

FIG. 5 illustrates a second embodiment of a modular power board in accordance with the present invention;

FIG. 6 illustrates the power board of FIG. 5 being connected to the battery backup module of FIG. 3;

FIG. 7 illustrates a modular UPS formed by a stack of battery backup modules similar to that of FIG. 3 with the modular power board of FIG. 5;

FIG. 8 illustrates a preferred embodiment of the electrical connectors within the modular UPS of FIG. 7;

FIG. 9 is a perspective view of the electrical connectors of FIG. 8;

FIG. 10 is an enlarged perspective view of one of the electrical connectors illustrated in FIG. 9;

FIG. 11 is a perspective view of a cover for an electrical connector in the base of a power module; and,

FIG. 12 is an enlarged perspective view of the cover of FIG. 11.

### DETAILED DESCRIPTION OF PREFERRED EMBODIMENTS

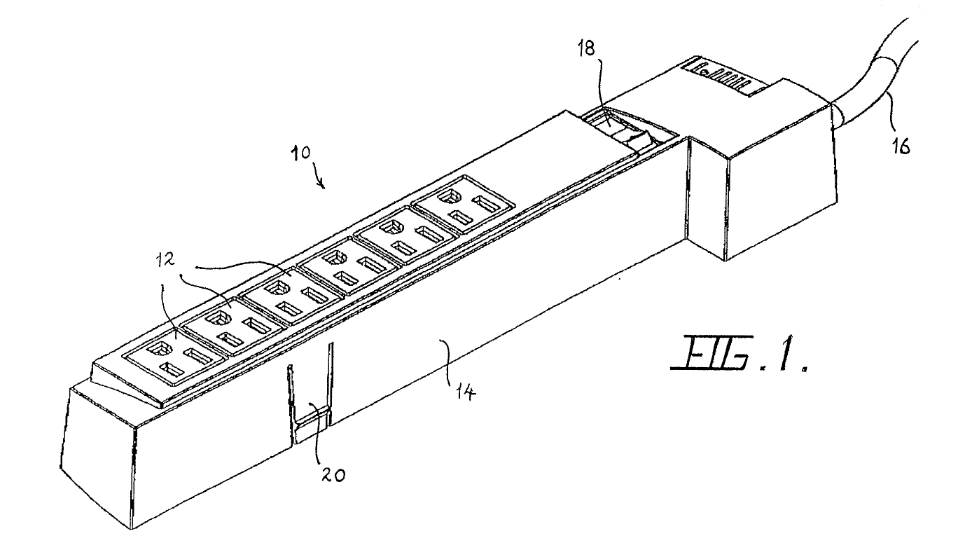

A first embodiment of an expandable power connector module in the form of a modular power board or modular power strip 10 is illustrated in FIG. 1. The modular power board 10 comprises a plurality of power sockets 12 provided on a base structure 14, each of the power sockets 12 being connected to a power cord 16 having a plug provided thereon (not shown) for connection to a mains power supply outlet (not shown). Up to six electrical appliances or devices, such as a PC and/or various peripheral devices, can be connected to the power board 10. The modular power board 10 also includes a power switch 18 for connecting or disconnecting the power sockets 12 from the power cord 16.

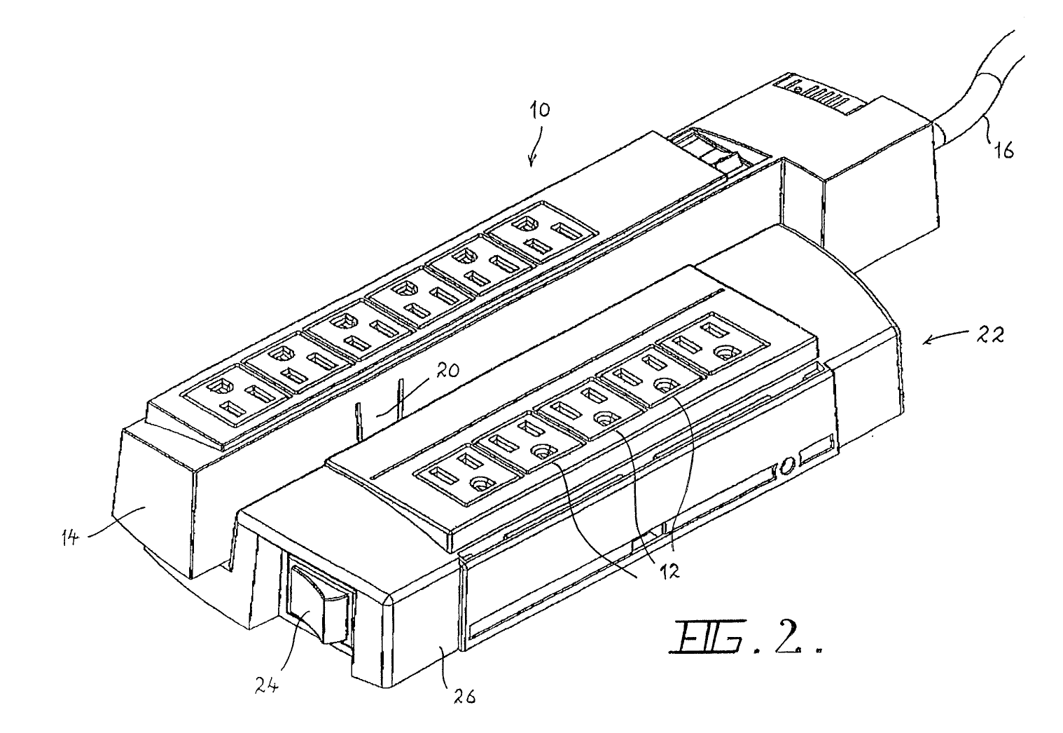

The base structure 14 is adapted to connect to one or more additional power modules and is provided with snap-on connectors 20 for physically connecting the base structure to one or more additional power modules (see FIG. 2). In this way, the function of the power board 10 can be expanded to provide additional power connection and/or conditioning features by connecting one or more additional power modules. FIG. 2 illustrates an example of an additional power module in the form of a second modular power board 22 which is connected to the first modular power board 10.

The second modular power board 22 illustrated in FIG. 2 is similar to the first power board 10 of FIG. 1, in that it has a single row of power sockets 12 arranged side by side in a linear array. In this case, five power sockets are provided together with a power switch 24 for connecting or disconnecting the power sockets from the power cord 16. The second power board 22 is also provided with a base structure 26 which is adapted to receive the base structure 14 of the first power board therein. The two base structures 14 and 26 clip together securely by means of the snap-on connector 20. The base structure 26 is provided with a mating connector (not shown) for receiving the snap-on connector 20 in locking engagement therewith. The base structures 14 and 26 are also provided with electrical connectors (not visible) for electrically connecting each of the power sockets 12 on the second power board 22 with the power cord 16 on the first power board 10. Preferably, either one or both of the first and second power boards 10 and 22 is also provided with surge protection means electrically connected to each of the power sockets 12 for protecting any devices connected to the sockets from excessive power surges in the mains power supply. The surge protection means may be of conventional design and has not been illustrated.

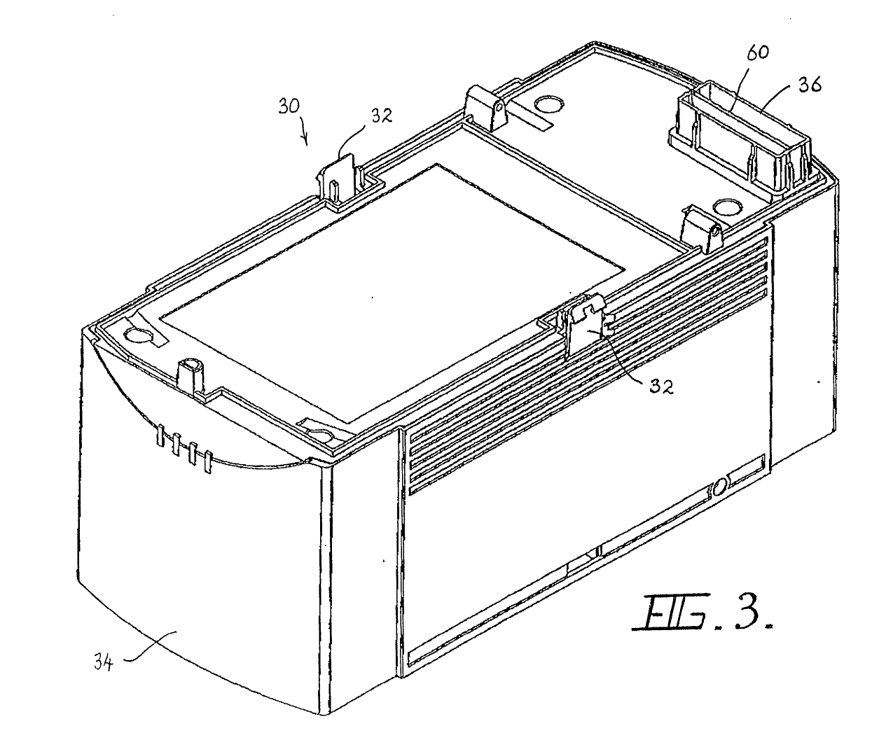

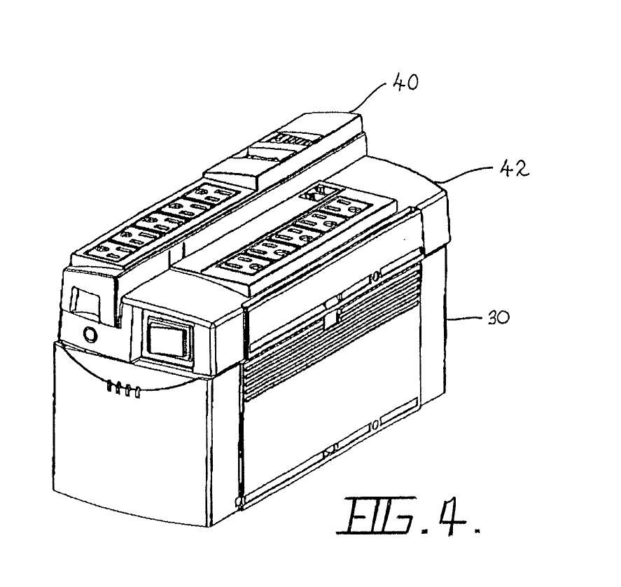

Advantageously the base structure 26 of the second modular power board 22 is adapted to connect to an additional power module in the form of a battery backup module 30 as illustrated in FIG. 3. The battery backup module 30 is an additional power module for providing power backup to any devices connected to the power sockets 12 in the event of a failure in the mains power supply. The battery backup module 30 is also provided with snap-on connectors 32 on either side of an upper surface of a casing 34 of the battery backup module. The base structure 26 of the second power module illustrated in FIG. 2 is provided with mating connectors for receiving the snap-on connectors 32 so that the base structure 26 snaps on to the upper surface of the casing 34 of the battery backup module 30. The battery backup module 30 is also provided with an electrical connector 36 for electrically connecting the power sockets 12 of the first and second power boards 10 and 22 with the batteries (not visible) within the casing 34 of the battery backup module 30. FIG. 4 illustrates the manner in which all three power modules of the modular power connector system are combined in a single unit.

A first modular power strip 40, which is a variation of the modular power strip 10 of FIG. 1, is connected to a second modular power strip 42 similar to the second modular power board 22 of FIG. 2. The base structure of the second modular power strip 42 is in turn connected to the battery backup module 30 in the manner described above. Advantageously, either one or both of the modular power strip 42 and battery backup module 30 are provided with electronic switching means therein for controlling the supply of electrical power from the battery backup module 30 to the power sockets 12 in the first and second power strips 40 and 42 in the event of a failure in the mains supply. In this way, when the power connector modules 40 and 42 and battery backup module 30 are connected together they form a modular uninterruptible power supply (UPS).

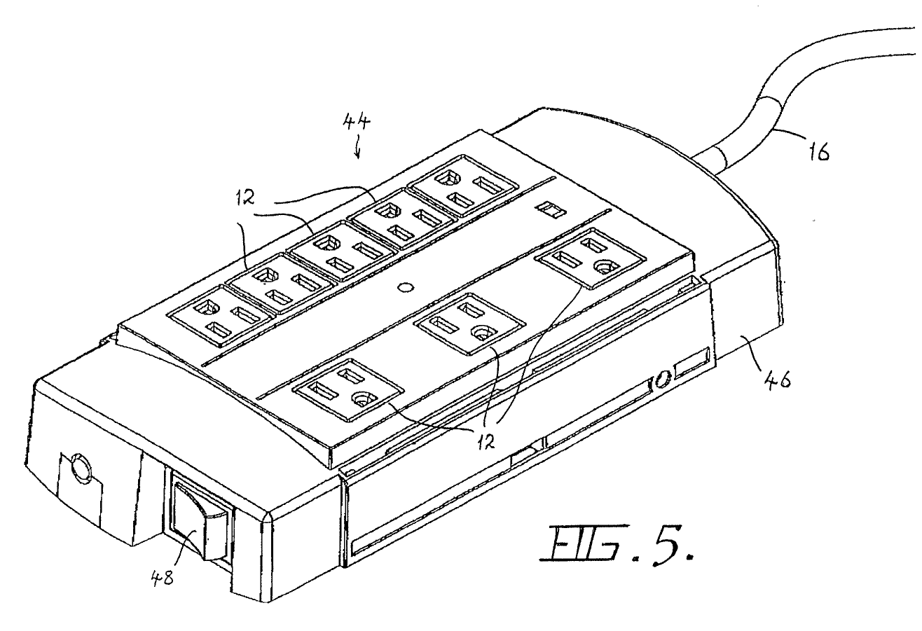

FIG. 5 illustrates a second embodiment of a modular power board 44 in accordance with the present invention. The modular power board 44 is similar to the first and second modular power boards 10 and 22 of the first embodiment, and the like parts are identified by the same reference numerals. In this embodiment, the power board 44 is provided with a pair of linear arrays of sockets 12 on a base structure 46 which is adapted to connect to one or more additional power modules in a similar fashion to the base structure 26 of the second power board 22. A power switch 48 is provided for connecting or disconnecting the power sockets 12 from the power cord 16. The modular power board 44 may also be provided with surge protection means as in the previous embodiment.

FIG. 6 illustrates the manner in which the power board 44 may be connected to a battery backup module 30 similar to that of FIG. 3. Clearly, the function of a power connector module, such as the power board 44, can be expanded to provide additional power connection and/or power conditioning features by adding one or more additional power modules. The additional power modules may incorporate additional power protection and/or power conditioning features, such as, for example, voltage regulation, and are not restricted to the battery backup modules 30 of the illustrated embodiments.

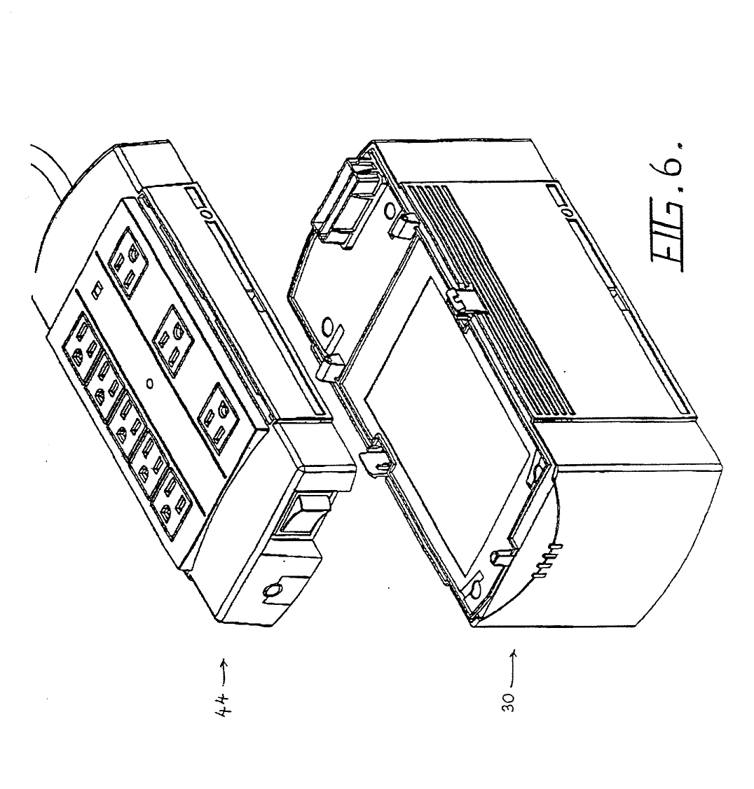

Advantageously the housing 34 of the battery backup module 30 (see FIGS. 3, 4 and 6) is in the form of a stackable housing whereby two or more battery backup modules can be stacked one on top of the other as illustrated in FIG. 7. In FIG. 7 the power board 44 of FIG. 5 has been connected to a battery backup module 30, which is in turn connected to two additional battery backup modules 30 of substantially identical form and structure. The number of battery backup modules 30 that can be stacked one on top of the other is limited only by the height to which the modules can be safely stacked without risk of toppling over. The bottom module may be provided with a foot 48 for improving the stability of the stack. In the illustrated embodiment, a single battery backup module provides 500 VA of backup power which typically lasts from between ten to twenty minutes during a power black out or brown out. Adding additional battery backup modules will increase the backup power or backup time to handle the most powerful desktop computer or small server. Two or three battery backup modules increases the backup power to 1,000 VA or extends the backup time by two to three times. This way, the modular power connector system can expand as the user's computer system grows.

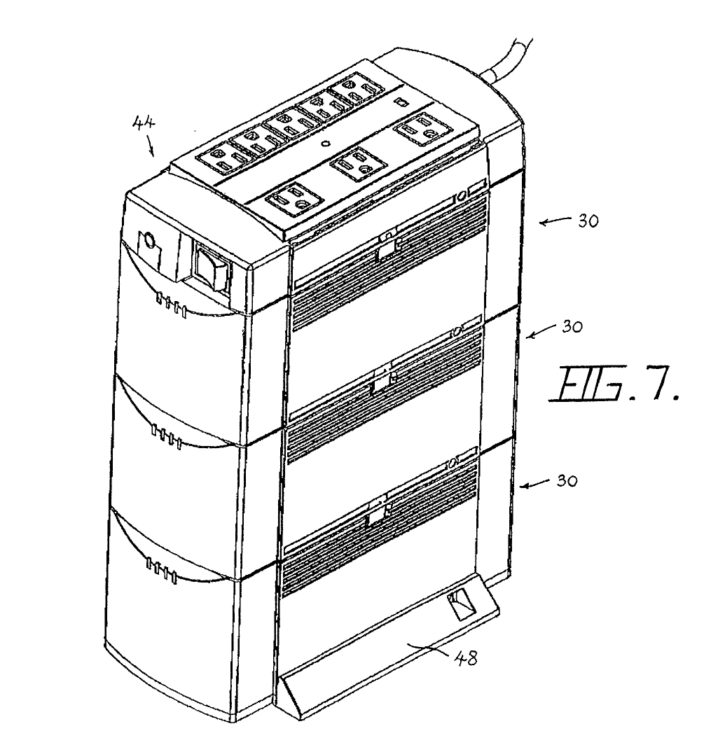

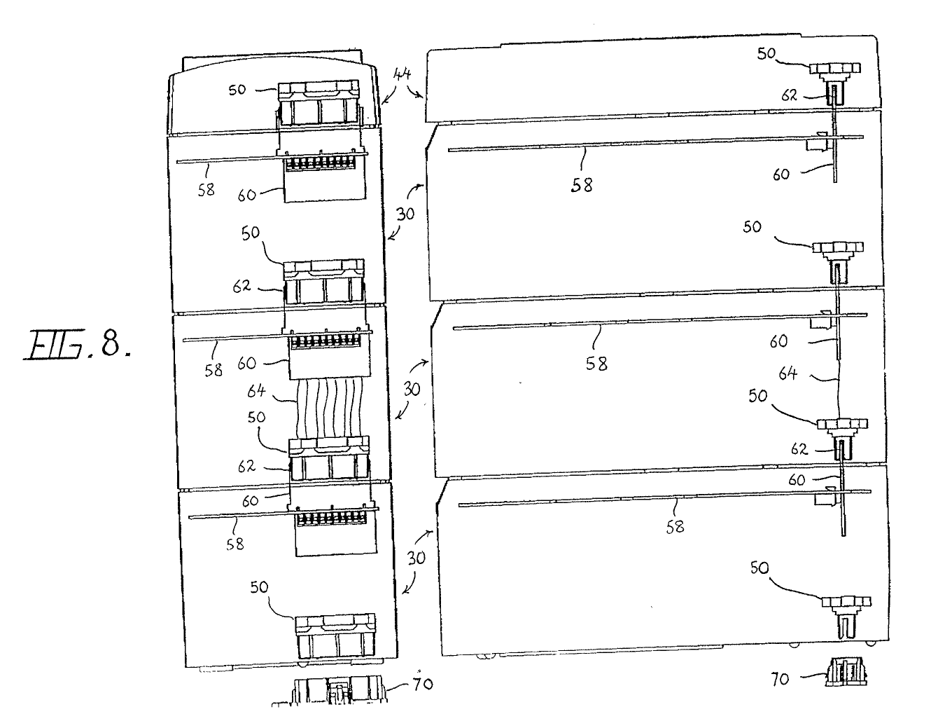

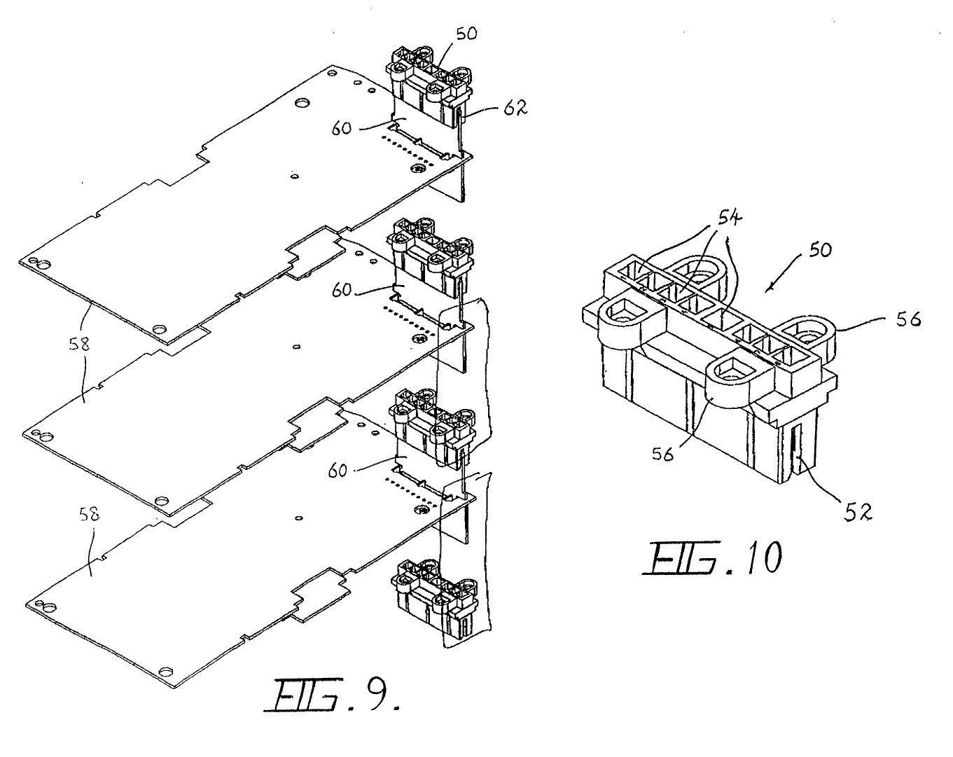

FIGS. 8 to 12 illustrate a preferred embodiment of the manner in which each of the power modules in the modular power connector system is electrically interconnected with the other modules. FIGS. 8 and 9 illustrate the electrical connections between each of the power modules in the modular UPS of FIG. 7 shown in side and end elevations respectively. Each module is provided with an electrical connector 50, an enlarged perspective view of which is illustrated in FIG. 10. The same connector 50 is used in each of the modules, and therefore lends itself to mass production. Each of the connectors 50 is provided with a slot 52 adapted to slidably receive an edge of a printed circuit board (PCB) therein, as can be seen most clearly in FIG. 9. In the illustrated embodiment of the electrical connector 50, eight gold-plated leaf spring contacts (not visible) are provided within the slot 52 for providing an electrical connection with a corresponding number of copper tracks provided on a PCB slidably received therein. On the rear end of the connector 50 eight terminals 54 are provided to which wires can be affixed to provide an electrical connection to each of the contacts within the slot 52. Lugs 56 on the connector 50 are provided for mounting the connector in place within the respective power modules using suitable fasteners, such as screws.

Each of the battery backup modules 30 has a large horizontal PCB 58 provided therein on which various circuit components, for example, a microprocessor controlled switching circuit for controlling the supply of electrical power from the batteries during a power failure, are mounted. The circuit components have been omitted from the drawings for clarity (see FIGS. 8 & 9). At one end of the PCB 58 is a smaller connecting PCB 60 which is mounted perpendicularly to the PCB 58, with one end 62 protruding through an upper surface of the module. The protruding end 62 of the PCB 60 (see FIG. 3) is received within the slot 52 of a connector 50 provided within an adjoining power module which is received on the top face of the battery backup module 30.

Each battery backup module 30 is provided with a connector 50 and a connecting PCB 60, which are electrically coupled by means of a plurality of wires 64, (which may be in the form of a ribbon cable), as illustrated in FIG. 8. The wires 64 have only been illustrated in the central battery backup module 30 in FIG. 8 for clarity, however, each of the two other battery backup modules are similarly configured. Thus, each connecting PCB 60 and connector 50 form a set of connectors, within each of the battery backup modules 30, to provide electrical connections with adjoining power modules within the modular power connector system. The top-most power module, in this case a power board 44, does not have a connecting PCB 60, since it is not designed to connect to additional power modules from its upper surface. Therefore, the power board 44 only has an electrical connector 50 provided therein for connecting to the protruding portion 62 of a connecting PCB 60 on the upper surface of a battery backup module 30 (see FIG. 8).

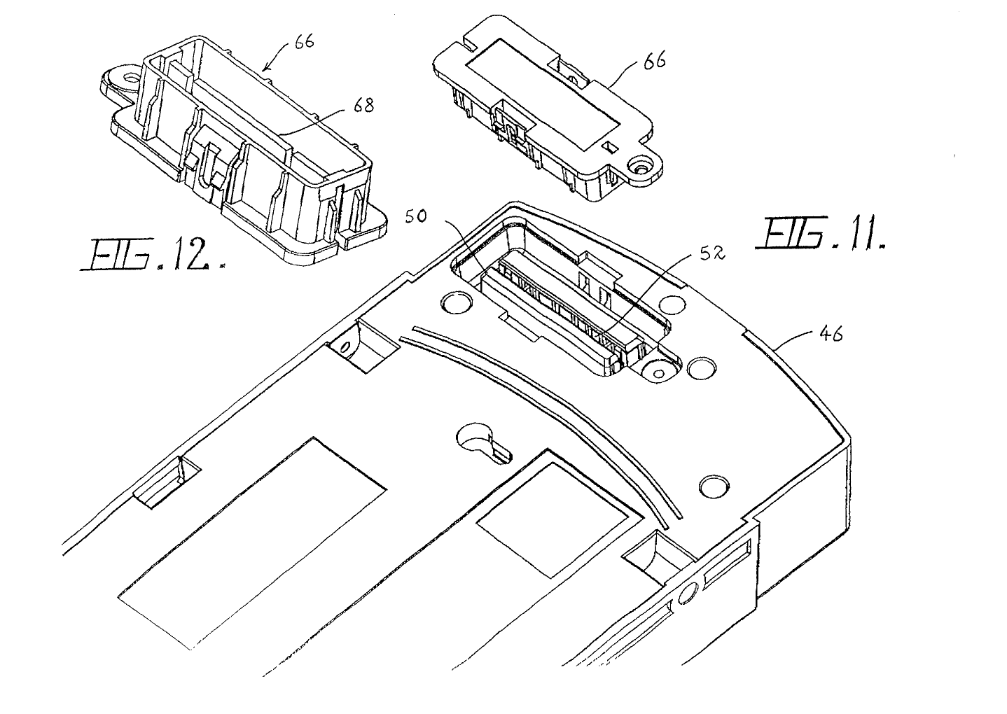

When a module is not stacked on top of another module, the exposed slot 52 of the connector 50 is covered by a plastic cover 66 as shown in FIG. 11. FIG. 11 illustrates the underside of the base structure 46 of the power board 44 of FIG. 5. The slot 52 of the connector 50 is visible through an aperture provided in the floor of the base structure 46. The plastic cover 66 clips into this aperture and is provided with a small PCB 68 therein which is received within the slot 52 of the connector 50. PCB 68 serves as a by-pass connection and links up the appropriate contacts in the connector 50 so that the input power is directed to the power sockets 12. The location of the PCB 68 within the cover 66 can be seen most clearly in FIG. 12. A similar cover 66 is used in the bottom of the other power modules of the modular power connector system. Cover 70 does not have a PCB 68 therein. The two types of cover 66 and 70 respectively are not interchangeable and there is a positive key slot to prevent the wrong cover being used. In FIG. 8 the cover 70 is provided within the bottom of the lower most battery backup module 30.

Now that several embodiments of the power connector module and additional power modules of the modular power connector system have been described in detail, it will be apparent that the system provides a number of advantages, including the following:

(a) A simple power strip or power board can be easily expanded to provide additional power sockets for peripheral devices;

(b) Well spaced-out power sockets accommodate a wide range of AC adaptors that are commonly used;

(c) Each power connector module can be provided with surge protection and other power protection features;

(d) A snap-on battery backup module instantly transforms the power board into an uninterrupible power supply (UPS);

(e) The battery backup power or backup time can be increased by adding additional battery backup modules to the system;

(f) The modular construction of the power connector system enables it to be readily expanded so that it grows with the users' computer system;

(g) Additional power protection and/or power conditioning features can be readily added to the system by connecting additional power modules.

Numerous variations and modifications will suggest themselves to persons skilled in the electrical arts, in addition to those already described, without departing from the basic inventive concepts. For example, any suitable forms of mechanical and electrical connectors can be employed for physically and electrically connecting the power modules in the system, for example, slide connectors or plug-in connectors. All such variations and modifications are to be considered within the scope of the present invention, the nature of which is to be determined from the foregoing description and the appended claims.

1. An expandable power connector module for connecting one or more electrical devices to a mains power supply outlet, the power connector module comprising:
a plurality of power sockets provided on a base structure, each of said power sockets being connected to a power cord for connection to a mains power supply outlet, the base structure being adapted to connect to one or more additional power modules and being provided with mechanical connecting means for physically connecting the base structure to said one or more additional power modules whereby, in use, the function of said power connector module can be expanded to provide additional power connection, power protection and/or power conditioning features.

2. An expandable power connector module as defined in clam 1, wherein said base structure is also provided with electrical connecting means for electrically connecting each of said power sockets to said one or more additional power modules.

3. An expandable power connector module as defined in claim 1, wherein said power connector module is in the form of a first modular power board having said plurality of power sockets arranged side by side in a linear array, and further comprising a power switch for connecting or disconnecting said power sockets from the power cord.

4. An expandable power connector module as defined in claim 3, wherein said linear array is one of a pair of linear arrays of sockets provided on the power board.

5. An expandable power connector module as defined in claim 3, wherein the first modular power board has a plurality of power sockets arranged in a single linear array and said base structure is adapted to connect to a second modular power board also having a plurality of power sockets arranged in a linear array.

6. An expandable power connector module as defined in claim 5, wherein either one or both of said first and second modular power boards is provided with surge protection means electrically connected to each of said plurality of power sockets for protecting any devices connected to the sockets from excessive power surges in the mains power supply.

7. An expandable power connector module as defined in claim 1, wherein said base structure of the power connector module is adapted to connect to an additional power module in the form of a battery backup module, for providing battery backup to any devices connected to the power sockets in the event of a failure in the mains power supply

8. An expandable power connector module as defined in claim 7, wherein said base structure snaps on to an upper surface of the battery backup module.

9. An expandable power connector module as defined in claim 7, wherein said battery backup module together with said power connector module form a modular uninterruptible power supply (UPS).

10. An expandable power connector module as defined in claim 9, wherein said battery backup module is provided with a stackable housing whereby, in use, two or more of said battery backup modules can be stacked one on top of the other to increase the backup power or backup time.

11. A modular uninterruptible power supply (UPS) comprising:
a power connector module having a plurality of power sockets provided on a base structure, the base structure being adapted to connect to one or more additional power modules and being provided with mechanical connecting means for physically connecting the base structure to said one or more additional power modules;
an additional power module in the form of a battery backup module for providing battery backup to any devices connected to the power sockets on the power connector module; and,
electronic switching means provided in either one or both of said power connector module and battery backup module for controlling the supply of electrical power from the battery backup module to the power sockets in the event of a failure in the mains power supply whereby, in use, when said power connector module and battery backup module are connected together they form an UPS.

12. A modular UPS as defined in claim 11, wherein said battery backup module is provided with a stackable housing whereby, in use, two or more of said battery backup modules can be stacked one on top of the other to increase the backup power or backup time.

13. A modular UPS as defined in claim 11, wherein said base structure snaps on to an upper surface of the battery backup module.

14. A modular UPS as defined in claim 11, wherein said base structure is also provided with electrical connecting means for electrically connecting each of said power sockets to said one or more additional power modules.

15. A modular UPS as defined in claim 14, wherein said electrical connecting means comprises an electrical connector having a slot adapted to receive a connecting printed circuit board (PCB) therein from an adjoining power module.
